(19) United States
(12) Patent Application Publication
(10) Pub. No.: US 2002/0167826 A1
(43) Pub. Date: Nov. 14, 2002

(54) Method for turning off an insulated gate bipolar transistor and apparatus for carrying out the method

(76) Inventors: Gerhard Hochstuhl, Waldshut-Tiengen (DE); Andreas Volken, Brugg (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/136,415

(22) Filed: May 2, 2002

(30) Foreign Application Priority Data
May 11, 2001 (EP) 01810465.3

(51) Int. Cl. H02H 7/10

(52) U.S. Cl. 363/50

(57) ABSTRACT

What is specified is a method for turning off an insulated gate bipolar transistor (IGBT) (1), which is driven by means of a gate electrode driver stage (2) which applies the gate-cathode voltage (UGK) between gate electrode (G) and cathode (K), the anode-cathode voltage of the IGBT (1) being monitored for desaturation and, in the event of desaturation, an acknowledgement signal (S_{R}) being output and fed to the gate electrode driver stage (2). Furthermore, in the event of desaturation, the gate-cathode voltage (U_{GK}) is reduced according to a differentiable function down to a value of the order of magnitude of the threshold value (U_{S}) of the gate-cathode voltage (U_{GK}) Furthermore, an apparatus for carrying out the method is disclosed, which comprises a turn-off device (4) for reducing the gate-cathode voltage (U_{GK})

### TECHNICAL FIELD

The invention relates to the field of power electronics. It is based on a method for turning off an insulated gate bipolar transistor (IGBT) and an apparatus for carrying out the method in accordance with the preamble of the independent claims.

### PRIOR ART

Field-controlled semiconductor switches, in particular insulated gate bipolar transistors (IGBTs), are currently being used to an increased extent in power electronic applications, such as in power converter technology and, in particular, in power converters for electrical drives or power supply couplings. They are driven via their gate electrode with the aid of a gate electrode driver stage by the application of a corresponding gate-cathode voltage.

In fault situations in power converter applications, a short circuit in the main current path of the IGBT, i.e. between the anode and cathode of the IGBT, can occur in the IGBTs in the power converter. In the case of a short circuit, the current in the main current path rises very rapidly to a high current amplitude, so that the current integral over time assumes impermissibly high values. During this overcurrent that occurs, the IGBT is driven into desaturation, the anode-cathode voltage on the IGBT rising rapidly, in particular to the value of the voltage to be switched. As a result, an extremely critical state of the IGBT is reached: on the one hand, the IGBT carries a high current (overcurrent) in the main current path via the anode and cathode. On the other hand, a high anode cathode voltage is simultaneously present between anode and cathode of the IGBT. This results in an extremely high instantaneous power loss, which can destroy the IGBT.

A suitable apparatus for turning off an IGBT is disclosed in DE 199 18 966 A1, in which the anode-cathode voltage of the IGBT is monitored for desaturation and, in the event of desaturation, an acknowledgement signal is output which is fed to the gate electrode driver stage. In response to the acknowledgement signal, the gate-cathode voltage is reduced in steps, in particular in two steps, and the IGBT is thus turned off. This stepwise reduction of the gate-cathode voltage brings about a rapid, likewise stepwise, reduction of the overcurrent in the main current path. Despite minimal parasitic inductances, in particular in the main current path at the anode of the IGBT, considerable overvoltages are induced by such rapid current changes. These overvoltages can exceed the maximum permissible reverse voltage of the IGBT and destroy the IGBT.

### SUMMARY OF THE INVENTION

It is an object of the invention, therefore, to specify a method for turning off an insulated gate bipolar transistor (IGBT) in which it is possible to avoid damage to the relevant IGBT and further components. Furthermore, the intention is to specify an apparatus with which the method is carried in a particularly simple manner. This object is achieved by means of the features of claims 1 and 8. Advantageous developments of the invention are specified in the subclaims.

In the case of the invention's method for turning off an insulated gate bipolar transistor (IGBT), which is driven by means of a gate electrode driver stage which applies the gate-cathode voltage between gate electrode and cathode, the anode-cathode voltage of the IGBT is monitored for desaturation. If desaturation occurs, then an acknowledgement signal is output and fed to the gate electrode driver stage. According to the invention, in the event of desaturation, the gate-cathode voltage is reduced according to a differentiable function down to a value of the order of magnitude of the threshold value of the gate-cathode voltage. The effect of this reduction is that rapid current changes, in particular abrupt current changes in the main current path, cannot occur, so that the occurrence of induced overvoltages on account of excessively rapid current changes can advantageously be reduced to a minimum. Damage to the IGBT and to further components can thus be avoided. Moreover, the thermal loading on the IGBT is reduced as a result of the abovementioned reduction of the gate-cathode voltage, as a result of which the service life of said IGBT is increased and increased availability of the IGBT can thus be achieved and, moreover, costs can be reduced.

The invention's apparatus for carrying out the method for turning off an IGBT comprises a gate electrode driver stage which applies the gate-cathode voltage to the gate electrode and cathode of the IGBT. Furthermore, the apparatus has a desaturation monitoring device—connected to the anode and cathode of the IGBT—for outputting the acknowledgement signal in the event of desaturation of the IGBT, said device being connected to the gate electrode driver stage. Furthermore, provision is made of a turn-off device for reducing the gate-cathode voltage down to a value of the order of magnitude of the threshold value of the gate-cathode voltage according to a differentiable function, said device being connected to the gate electrode and cathode of the IGBT. The implementation apparatus according to the invention can thus be realized very simply and cost-effectively, since the outlay on circuitry can be kept extremely low and, moreover, only a small number of components are required for the construction.

In a preferred embodiment of the apparatus according to the invention, the turn-off device has a switch with a temporally variable resistance characteristic. As a result, the differentiable function according to which the gate-cathode voltage is reduced can be generated particularly simply, so that a further reduction of the costs can advantageously be achieved.

This and further objects, advantages and features of the present invention will become apparent from the following detailed description of a preferred exemplary embodiment of the invention in conjunction with the drawing.

### BRIEF DESCRIPTION OF THE DRAWINGS

In the figures:

FIG. 1 shows an embodiment of an apparatus according to the invention for carrying out a method for turning off an insulated gate bipolar transistor (IGBT),

FIG. 2 shows an embodiment of a turn-off device according to the invention, and

FIG. 3 shows a temporal profile of the gate-cathode voltage of the IGBT for a turn-off operation of the IGBT.

The reference symbols used in the drawing and their meanings are summarized in the List of designations. In principle, identical parts are provided with identical reference symbols in the figures. The embodiment described is an example of the subject matter of the invention and has no restrictive effect.

### WAYS OF EMBODYING THE INVENTION

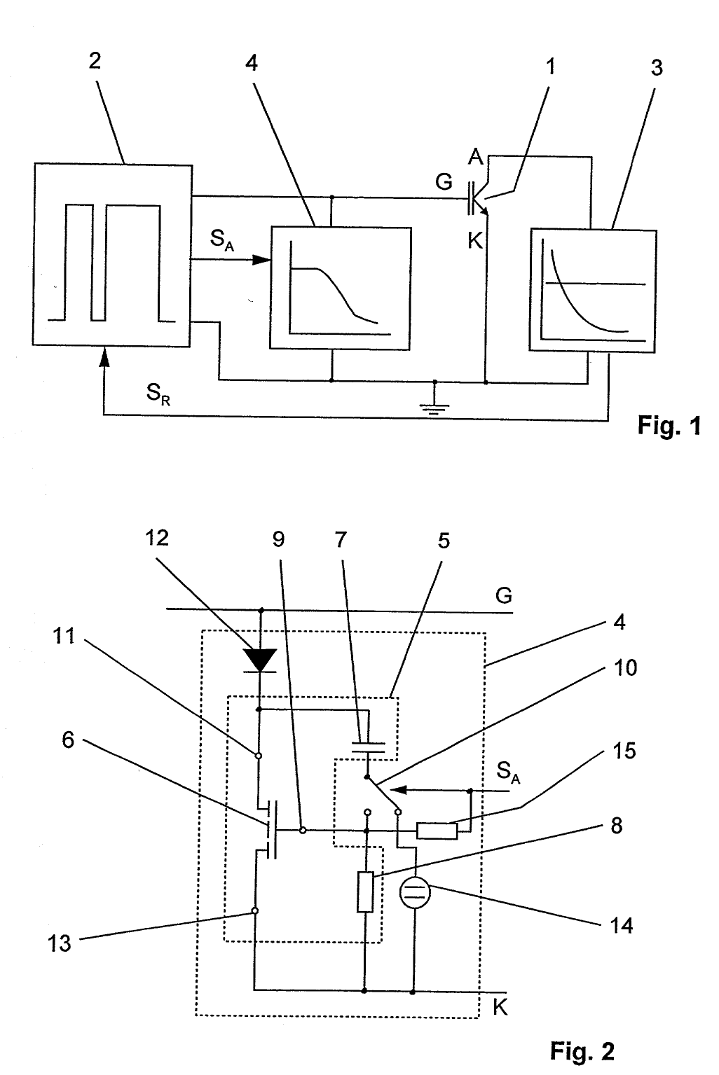

FIG. 1 illustrates an embodiment of an apparatus according to the invention for carrying out a method for turning off an insulated gate bipolar transistor (IGBT) 1. The apparatus has a gate electrode driver stage 2, which, in accordance with FIG. 1, is connected to the gate electrode G of the IGBT 1 and the cathode K of the IGBT 1, the gate electrode driver stage 2 driving the IGBT 1 by the application of a gate-cathode voltage UGK, in particular by the application of a positive voltage potential for the gate-cathode voltage UGK for turning on the IGBT 1.

In the method according to the invention, the anode-cathode voltage present between the anode A of the IGBT 1 and the cathode K is monitored for desaturation. If this desaturation occurs, i.e. if the anode-cathode voltage rises to an impermissible value with the IGBT 1 turned on, an acknowledgement signal S_{R} is output and fed to the gate electrode driver stage 2. According to the invention, in the event of the above-described desaturation of the IGBT 1, the gate-cathode voltage U_{GK} is then reduced according to a differentiable function down to a value of the order of magnitude of the threshold value Uₛ of the gate-cathode voltage U_{GK}. The reduction according to the differentiable function advantageously has the effect that rapid current changes, in particular abrupt current changes, cannot occur in the main current path between anode A and cathode K. The occurrence of overvoltages, brought about by induction of parasitic inductances, in particular in the main current path at the anode A, can thus be reduced to the desired extent. Furthermore, it is possible to successfully avoid damage to the IGBT 1 or to further components, not illustrated in FIG. 1 for the sake of clarity, as a result of the reduction of the gate-cathode voltage U_{GK}. Preferably, a turn-off signal S_{A} is generated in response to the acknowledgement signal S_{R} and the reduction explained above is started as a result of the outputting of the turn-off signal S_{A}.

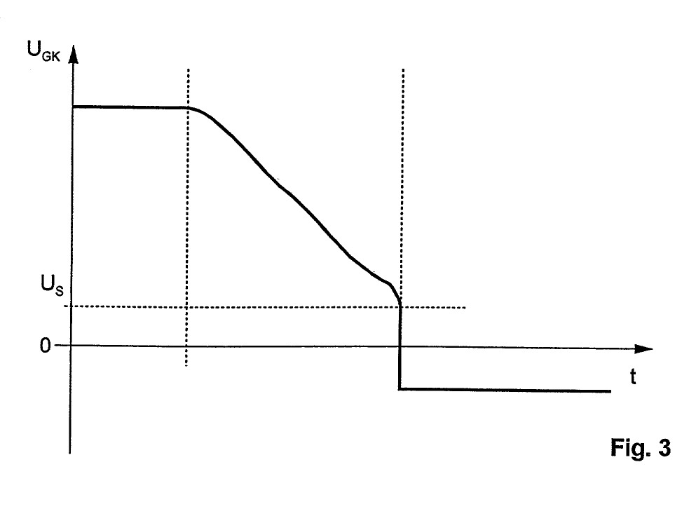

FIG.3 shows a temporal profile of the gate-cathode voltage U_{GK} for a turn-off operation of the IGBT 1, the gate-cathode voltage U_{GK} being at a positive voltage potential with the IGBT 1 turned on before the reduction of the gate-cathode voltage U_{GK} is started. In accordance with FIG. 3, the reduction proceeds according to a differentiable function. For the reduction of the gate-cathode voltage U_{GK}, it has proved to be advantageous for the differentiable function to have an essentially ramped profile. In accordance with FIG. 3, such a function has no undifferentiable points, such as kinks for example, so that no rapid current changes are brought about in the main current path and, consequently, it is possible to achieve a further reduction in the occurrence of overvoltages. Preferably, the gate-cathode voltage U_{GK} is reduced temporally in the range between 2 μs and 6 μs. What is advantageously achieved by this range is that the instantaneous power loss of the IGBT does not rise to impermissibly high values and, at the same time, no impermissibly high overvoltages are generated.

According to the invention, the gate-cathode voltage U_{GK} is reduced, as already mentioned above, down to a value of the order of magnitude of the threshold value Uₛ of the gate-cathode voltage U_{GK}. This reduction down to a value of the order of magnitude of the threshold value Uₛ of the gate-cathode voltage U_{GK} has the effect that the current in the main current path is reduced in the event of desaturation of the IGBT 1 to an extent such that the IGBT 1 can be turned off without the current changing in such a way that impermissibly high overvoltages are generated on account of induction in parasitic inductances in the main current path. After this reduction, the gate-cathode voltage U_{GK} is lowered, according to the invention, to a value below the threshold value Uₛ of the gate-cathode voltage U_{GK}, this lowering advantageously being effected by means of the gate electrode driver stage 2. To that end, the gate electrode driver stage 2 applies a negative voltage potential between the gate electrode G and the cathode K, so that the gate-cathode voltage UGK is pulled to the negative voltage potential and the IGBT 1 can be turned off in a desired manner.

The invention's apparatus for carrying out the method has, in accordance with the embodiment illustrated in FIG. 1, in addition to the gate electrode driver stage 2 already mentioned, a desaturation monitoring device 3, which is connected to the anode A of the IGBT 1 and the cathode K and serves for outputting the acknowledgement signal S_{R} in the event of desaturation of the IGBT 1. Said desaturation monitoring device 3 is connected to the gate electrode driver stage 2 for the purpose of feeding the acknowledgement signal S_{R} to said stage.

According to the invention, the apparatus in accordance with FIG. 1 comprises a turn-off device 4, which is provided for reducing the gate-cathode voltage U_{GK} and reduces the gate-cathode voltage U_{GK} down to a value of the order of magnitude of the threshold value Uₛ of the gate-cathode voltage U_{GK} according to a differentiable function, the turn-off device 4 being connected to the gate electrode G and the cathode K. This results in a construction which is particularly simple to realize and, moreover, is cost-effective, since the outlay on circuitry can be kept very low and only a small number of components are required for a construction.

The gate electrode driver stage 2 serves for generating the turn-off signal S_{A} in response to the acknowledgement signal S_{R}, the reduction of the gate-cathode voltage U_{GK} being started in the manner described as a result of the outputting of the turn-off signal S_{A} to the turn-off device 4. For this purpose, the gate electrode driver stage 2 is connected to the turn-off device 4.

An embodiment of a turn-off device 4 according to the invention which is illustrated in FIG. 2 is explained in more detail below. In accordance with FIG. 2, the turn-off device 4 has a switch 5 with a temporally variable resistance characteristic. As a result, the differentiable function according to which the gate-cathode voltage U_{GK} is reduced can be generated particularly simply. In accordance with FIG. 2, the switch 5 comprises a metal oxide field-effect transistor (MOSFET) 6, a capacitor 7 and also a first resistor 8. A changeover switch 10 is connected to the control terminal 9 of the MOSFET 6 and can be controlled by the turn-off signal S_{A} of the gate electrode driver stage 2. The capacitor 7 can be connected to the control terminal 9 by means of the changeover switch 10. Furthermore, a voltage source 14, which is preferably designed as a DC voltage source, can be connected to the capacitor 7 by the changeover switch 10. Furthermore, the capacitor 7 in accordance with FIG. 2 is connected to a first main terminal 11 of the MOSFET 6, the first main terminal 11 additionally being connected to the gate electrode G of the IGBT 1 via a diode 12. In accordance with FIG. 2, the first resistor 8 of the switch 5 is connected to the control terminal 9 and a second main terminal 13 of the MOSFET 6, the second main terminal 13 being connected to the cathode K of the IGBT 1. Furthermore, a second resistor 15 is provided, which is connected to the control terminal 9. In accordance with FIG. 2, the MOSFET 6 can be controlled by the turn-off signal S_{A} at its control terminal 9 via the second resistor 15.

During normal operation of the turned-on IGBT 1, the changeover switch 10 is changed over in such a way that the capacitor 7 is connected to the voltage source 14. The capacitor 7 is thus charged to the voltage value which corresponds to the gate-cathode voltage U_{GK} minus the value of the voltage source 14. The MOSFET 6 turns off in this state. If desaturation of the IGBT 1 then occurs, the changeover switch 10 is driven by the turn-off signal S_{A}, which is output by the gate electrode driver stage 2 in the event of desaturation, in such a way that the changeover switch 10 connects the capacitor 7 to the control terminal 9 of the MOSFET 6. At the same time, the MOSFET 6 is driven by the turn-off signal S_{A} at its control terminal 9 via the second resistor 15. By virtue of the already precharged capacitor 7, the MOSFET 6 can be brought very rapidly to the start value of the on state of the MOSFET 6, without valuable time elapsing until this point is reached. Moreover, it is thus advantageously possible to avoid undifferentiable points such as kinks or spikes when starting the reduction of the gate-cathode voltage U_{GK}. Furthermore, the capacitor 7 undergoes charge reversal in such a way that the voltage at the control terminal 9 increases and the current between first main terminal 11 and second main terminal 13 continuously rises and the MOSFET 6 turns on more and more. This current rise is accompanied by the reduction—already described—of the gate-cathode voltage U_{GK}, as is shown in the temporal profile of the gate-cathode voltage U_{GK} for a turn-off operation of the IGBT 1 in accordance with FIG. 3. The switch 5 thus has a temporally variable resistance characteristic which corresponds to a temporally decreasing resistance behavior. The differentiable function for reducing the gate-cathode voltage U_{GK} can be realized particularly simply with this temporal behavior of the resistance characteristic. The temporal profile of this reduction can be set precisely and with little outlay through the choice of the value of the first resistor 8, of the second resistor 15 and of the value of the capacitor 7. Furthermore, this choice also enables very precise setting of the value to which the gate-cathode voltage U_{GK} is to be reduced, this value advantageously being of the order of magnitude of the threshold value Uₛ of the gate-cathode voltage U_{GK}. The further lowering of the gate-cathode voltage U_{GK} is effected by the gate electrode driver stage 2 in the manner already explained.

Overall, the apparatus according to the invention is distinguished by a very simple and cost-effective construction, since the outlay on circuitry is extremely low and, moreover, only a small number of components are required for the construction.

List of reference symbols

1 Insulated gate bipolar transistor (IGBT)

2 Gate electrode driver stage

3 Desaturation monitoring device

4 Turn-off device

5 Switch

6 Metal oxide field-effect transistor (MOSFET)

7 Capacitor

8 First resistor

9 Control terminal

10 Changeover switch

11 First main terminal

12 Diode

13 Second main terminal

14 Voltage source

15 Second resistor

1. A method for turning off an insulated gate bipolar transistor (IGBT) (1), which is driven by means of a gate electrode driver stage (2) which applies the gate-cathode voltage (U_{GK}) between gate electrode (G) and cathode (K), the anode-cathode voltage of the IGBT (1) being monitored for desaturation and, in the event of desaturation, an acknowledgement signal (S_{R}) being output and fed to the gate electrode driver stage (2), characterized in that, in the event of desaturation, the gate-cathode voltage (U_{GK}) is reduced according to a differentiable function down to a value of the order of magnitude of the threshold value (U_{S}) of the gate-cathode voltage (U_{GK}).

2. The method as claimed in claim 1, characterized in that a turn-off signal (S_{A}) is generated in response to the acknowledgement signal (S_{R}) and the reduction of the gate-cathode voltage (U_{GK}) is started as a result of the outputting of the turn-off signal (S_{A}).

3.The method as claimed in claim 1 or 2, characterized in that the function has an essentially ramped profile.

4. The method as claimed in one of the preceding claims, characterized in that the gate-cathode voltage (U_{GK}) is reduced temporally in the range between 2 μs and 6 μs.

5. The method as claimed in one of the preceding claims, characterized in that the gate-cathode voltage (U_{GK}) is lowered after the reduction to a value below the threshold value (U_{S}).

6. The method as claimed in claim 5, characterized in that the gate-cathode voltage (U_{GK}) is lowered by means of the gate electrode driver stage (2).

7. The method as claimed in claim 6, characterized in that the gate electrode driver stage (2) applies a negative voltage potential between the gate electrode (G) and the cathode (K).

8. An apparatus for carrying out a method for turning off an insulated gate bipolar transistor (IGBT), which comprises a gate electrode driver stage (2) which applies the gate-cathode voltage (U_{GK}) to the gate electrode (G) and cathode (K) of the IGBT (1), and has a desaturation monitoring device (3) connected to the anode (A) and the cathode (K) of the IGBT (1)—for outputting an acknowledgement signal (S_{R}) in the event of desaturation of the IGBT (1), which device is connected to the gate electrode driver stage (2), characterized in that a turn-off device (4) is connected to the gate electrode (G) and the cathode (K), which turn-off device is provided for reducing the gate-cathode voltage (U_{GK}) down to a value of the order of magnitude of the threshold value (U_{S}) of the gate-cathode voltage (U_{GK}) according to a differentiable function.

9. The apparatus as claimed in claim 8, characterized in that the gate electrode driver stage (2) is connected to the turn-off device (4) for the purpose of outputting to the turn-off device (4) a turn-off signal (S_{A}) generated in response to the acknowledgement signal (S_{R}).

10. The apparatus as claimed in claim 9, characterized in that the turn-off device (4) has a switch (5) with a temporally variable resistance characteristic.

11. The apparatus as claimed in claim 10, characterized in that the switch (5) has a metal oxide field-effect transistor (MOSFET) (6), a capacitor (7) and a first resistor (8).

12. The apparatus as claimed in claim 11, characterized in that a changeover switch (10) which can be controlled by the turn-off signal (S_{A}) is connected to the control terminal (9) of the MOSFET (6), in which case the capacitor (7) can be connected to the control terminal (9) by the changeover switch (10).

13. The apparatus as claimed in claim 12, characterized in that a second resistor (15) is connected to the control terminal (9), in which case the MOSFET (6) can be controlled by the turn-off signal (S_{A}) at its control terminal (9) via the second resistor (15).

14. The apparatus as claimed in one of claims 11 to 13, characterized in that the capacitor (7) is connected to a first main terminal (11) of the MOSFET (6), the first main terminal (11) being connected to the gate electrode (G) of the IGBT (1) via a diode (12).

15. The apparatus as claimed in one of claims 12 to 14, characterized in that the first resistor (8) is connected to the control terminal (9) and a second main terminal (13) of the MOSFET (6), the second main terminal (13) being connected to the cathode (K) of the IGBT (1).

16. The apparatus as claimed in claim 12, characterized in that a voltage source (14) can be connected to the capacitor (7) by the changeover switch (10).
